(19) United States
(12) Patent Application Publication
(10) Pub. No.: US 2008/0080938 A1
(43) Pub. Date: Apr. 3, 2008

(54) Cutting tool and manufacture method for the same

(75) Inventors: Yukitaka Makino, Suzuka-city (JP); Hideki Hayashi, Yokkaichi-city (JP); Toshiki Hirukawa, Kuwana-city (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/903,805

(22) Filed: Sep. 25, 2007

(30) Foreign Application Priority Data
Sep. 29, 2006 (JP) 2006-269098

(51) Int. Cl. B23B 27/14; C22C 33/02

(52) U.S. Cl. 407/114; 419/11

(57) ABSTRACT

A cutting tool for processing a nonferrous metal member by rotation has a body portion and a cutting edge arranged at the body portion. The body portion has a coolant supply hole through which a coolant is supplied for the nonferrous metal member in processing, and a chip evacuation groove which has a substantially helical shape and through which chip of the nonferrous metal member generated in the processing is expelled. The cutting edge is made of diamond grains and a binder material. An opening of the coolant supply hole is arranged at the cutting edge.

### CROSS REFERENCE TO RELATED APPLICATION

This application is based on a Japanese Patent Application No. 2006-269098 filed on Sep. 29, 2006, the disclosure of which is incorporated herein by reference.

### FIELD OF THE INVENTION

The present invention relates to a cutting tool and a manufacture method for the same.

### BACKGROUND OF THE INVENTION

Generally, a cutting tool is provided to process (work) a processed member which is made of a nonferrous metal. In the case where the cutting tool processes a processed member which is made of the nonferrous metal or the like, the chip of the nonferrous metal cut by the cutting tool may be welded (deposited) at the cutting tool so that the processing accuracy is deteriorated and the cutting tool is damaged. Therefore, it is necessary to restrict the chip from being welded at the cutting tool.

With reference to JP-11-309609A and JP-2006-130578A, the technology for restricting the chip from being welded at the cutting tool is disclosed. According to JP-11-309609A, a diamond sintered compact (body) is brazed at a cutting edge which is arranged at a base material of a superhard alloy. According to JP-2006-130578A, a diamond is coated at the surface of the base material of the superhard alloy by a predetermined film-forming condition.

However, as disclosed in JP-11-309609A, in the case where the diamond sintered compact is brazed at the base material, it is difficult to braze the diamond sintered compact if the base material is twisted to arrange a chip evacuation groove in order to rake outward the chip from the processing field. Moreover, it is difficult to arrange the chip evacuation groove (through which chip is raked from the processing field) at the base member where the diamond sintered compact is brazed. Therefore, according to JP-11-309609A, in the case where the diamond sintered compact is brazed at the base material, the welding of the chip to the cutting tool cannot be substantially restricted because the chip evacuation capacity is deteriorated.

Moreover, it is also considered that the diamond is sintered integrally with the cutting edge. However, in this case, it is difficult to arrange an opening portion of a coolant supply hole at the cutting edge. Therefore, the chip evacuation capacity is deteriorated so that it is difficult to substantially restrict the chip from being welded at the cutting tool.

According to JP-2006-130578A, in the case where the diamond is coated at the base material, the coating of the diamond may fall off due to the processing (which is repeated) so that the base material is exposed, although the chip evacuation groove can be arranged. Therefore, the chip will be welded at the based material which is exposed.

### SUMMARY OF THE INVENTION

In view of the above-described disadvantage, it is an object of the present invention to provide a cutting tool where chip welding can be substantially restricted, and a manufacture method of the cutting tool.

According to a first aspect of the present invention, a cutting tool for processing a nonferrous metal member by rotation is provided with a body portion and a cutting edge which is arranged at the body portion. The body portion has a coolant supply hole through which a coolant is supplied for the nonferrous metal member in processing, and a chip evacuation groove which has a substantially helical shape and through which chip of the nonferrous metal member generated in the processing is expelled. The cutting edge is arranged at the body portion, and made of diamond grains and a binder material. An opening of the coolant supply hole is arranged the cutting edge.

Because the opening of the coolant supply hole is formed at the cutting edge which is made of the diamond having a low compatibility with the nonferrous metal and the chip evacuation groove is provided, the chip can be substantially restricted from being welded at the cutting edge.

According to a second aspect of the present invention, a manufacture method for a cutting tool includes a pressing process for pressing a binder material and diamond grains which are filled in a field of a molding die corresponding to a cutting edge of the cutting tool and pressing a binder material and metal grains which are filled in a field of the molding die corresponding to a part of the cutting tool other than the cutting edge, so that a molding member is formed, a first sintering process for preliminarily sintering the molding member after the processing process, a perforation process for forming a coolant supply hole which is arranged at the molding member having been preliminarily sintered and has an opening at the cutting edge after the preliminary sintering process, and a second sintering process for further sintering the molding member which has been preliminarily sintered and provided with the coolant supply hole after the perforation process. The inner surface of the molding die has a shape corresponding to at least the cutting edge and a chip evacuation groove of the cutting tool. The chip evacuation groove has a substantially helical shape.

In this case, because the chip evacuation groove having the opening at the cutting edge is formed at the molding member which has been pressed by filling the binder material and the diamond grains in the field of the molding die corresponding to the cutting edge and which is preliminary sintered, the opening of the coolant supply hole can be formed at the cutting edge which is made of the diamond having the low compatibility with the nonferrous metal and the chip evacuation groove can be provided. Thus, the cutting tool where the chip is substantially restricted from being welded at the cutting edge can be manufactured.

### BRIEF DESCRIPTION OF THE DRAWINGS

Other objects, features and advantages of the present invention will become more apparent from the following detailed description made with reference to the accompanying drawings, in which:

FIG. 1 is a schematic sectional view showing a drill according to an exampled embodiment of the present disclosure;

FIG. 2 is a perspective view showing a pulverization-mixture process of a manufacture method of the drill according to the exampled embodiment;

FIG. 3 is a perspective view showing a drying process of the manufacture method of the drill according to the exampled embodiment;

FIG. 4 is a perspective view showing a pressing process of the manufacture method of the drill according to the exampled embodiment;

FIG. 5 is a perspective view showing a preliminary sintering process of the manufacture method of the drill according to the exampled embodiment;

FIG. 6 is a perspective view showing a perforation process of the manufacture method of the drill according to the exampled embodiment; and

FIG. 7 is a perspective view showing a full-scale sintering process of the manufacture method of the drill according to the exampled embodiment.

### DETAILED DESCRIPTION OF THE EXAMPLED EMBODIMENTS

### Exampled Embodiment

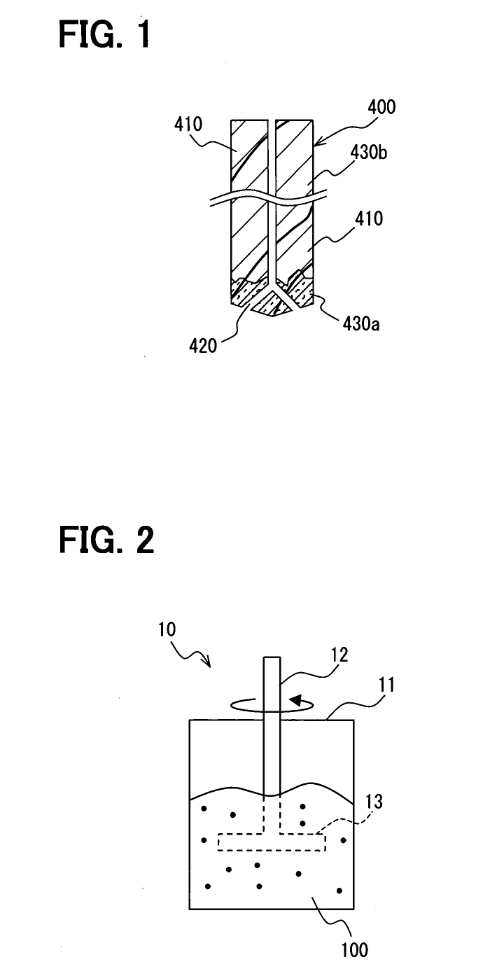

A cutting tool according to an exampled embodiment of the present invention will be described with reference to FIGS. 1-7. The cutting tool can be suitably used as a drill 400, for example.

The drill 400 can be used to process a nonferrous metal member (for example, aluminum member), while rotating. As shown in FIG. 1, the drill 400 has a substantially cylindrical shape and has a central axis as a rotation axis. The drill 400 has a shank portion (not shown) and a cutting portion 430b (body portion) which are respectively arranged at two axial-direction ends (e.g., rear end portion and front end portion) of the drill 400. The cutting portion 430b has a diameter which is slightly smaller than that of the shank portion. Furthermore, a cutting edge 430a is arranged at the cutting portion 430b and positioned at the tip thereof, for example. That is, the cutting edge 430a of the cutting portion 430b is positioned at an opposite side to the shank portion.

The cutting portion 430b can be provided with a pair of chip evacuation grooves 410 (toward the rear end side of the shank portion) which extends from the cutting edge 430a (at the tip of the drill 400) to a position immediately adjacent to the shank portion.

The chip evacuation groove 410 is formed at the outer surface of the cutting portion 430b. The chip evacuation grooves 410 can be symmetric to each other with respect to the rotation axis of the drill 400. The chip evacuation groove 410 has a helical shape which twists to the rear side of the rotation direction of the drill 400 when a perforation process is processed, with heading for the side of the rear end side. The helical shape has a central axis corresponding to the rotation axis of the drill 400. Cutting chips (of the processed member such as the aluminum member) generated in the processing (working) by the cutting edge 430a is expelled from the processed portion through the chip evacuation groove 410.

The drill 400 is provided with a pair of coolant supply holes 420 through which coolant is supplied and which extend from the side of the rear end toward the side of the front end of the drill 400. The coolant supply hole 420 is arranged at the cutting portion 430b in such a manner that the coolant supply hole 420 is spaced from the chip evacuation groove 410, and has an opening at the cutting edge 430a.

In this case, the cutting edge 430a at the cutting portion 430b of the drill 400 can be made of a diamond, and the other part (that is, the part other than cutting edge 430a) of the drill 400 is made of a hard material such as a superhard alloy and the like. That is, the drill 400 is provided with the cutting edge 430a made of the diamond, and has the chip evacuation groove 410 at the outer surface of the drill 400. Furthermore, the drill 400 has therein the coolant supply hole 420 which is provided with the opening at the cutting edge 430a. Thus, the welding (deposition) of the cutting chip at the cutting edge 430a can be substantially restricted.

Next, the manufacture method of the drill 400 will be described. According to this embodiment, the drill 400 is manufactured by a powder metallurgy method where powders constructing the base material of the drill 400 are sintered and pressed.

As shown in FIG. 2, at first, a pulverization-mixture process is performed. In this process, a superhard alloy material 100 such as a tungsten carbide and the like of which the part of the drill 400 other than the cutting edge 430a at the cutting portion 430b is made is pulverized and mixed in an Attritor 10 or the like. The Attritor 10 includes a container 11, and a rod 12 having a blade 13 which is positioned at an end of the rod 12 and housed in the container 11.

The superhard alloy material 100 is provided in the container 11, and the rod 12 is rotated so that the superhard alloy material 100 is pulverized and mixed by the blade 13.

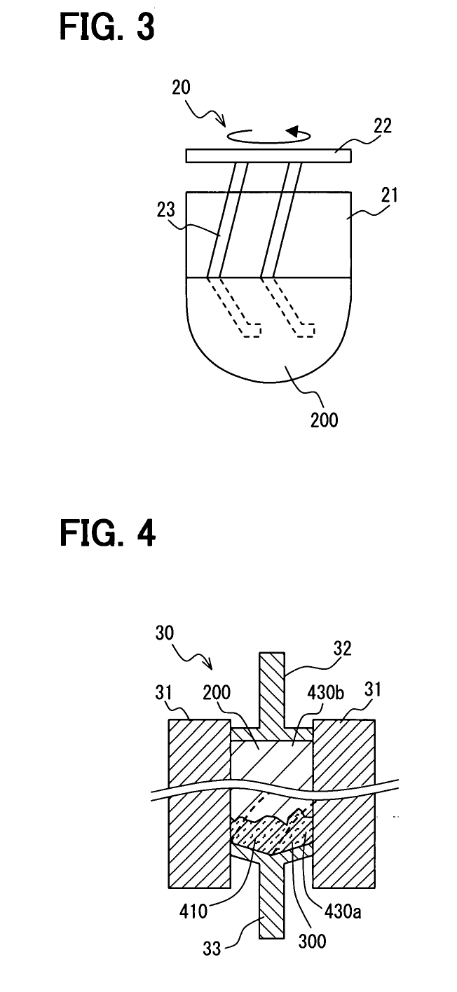

Next, as shown in FIG. 3, a mixture-drying process is performed. In this case, a binder is mixed with the superhard alloy material 100 in a stirring device 20 and dried, to produce a binder-containing superhard alloy material 200 in which the binder is provided. The stirring device 20 has a base portion 22 where a stirring portion 23 is mounted, and a container 21 in which an end portion of the stirring portion 23 and the like is housed.

The superhard alloy material 100 and the binder are provided in the container 21 of the stirring device 20, and the base portion 22 is rotated to mix the superhard alloy material 100 with the binder and dry the superhard alloy material 100 and the binder. Thus, the binder-containing superhard alloy material 200 can be produced.

A sieving process can be performed after the mixture-drying process. The pulverization-mixture process and the mixture-drying process can be also performed for the diamond grain which is the material of the cutting edge 430a arranged at the cutting portion 430b, and the indication thereof by figure is omitted.

Next, as shown in FIG. 4, a pressing (molding) process is performed via a pressing device 30 (for example, oil-hydraulic pressing device) which has a molding die 31 and the like. In this case, a binder-containing diamond material 300 (that is, material consisted of binder and diamond grain) and the binder-containing superhard alloy material 200 (that is, material consisted of binder and superhard alloy material 100) are pressed so that a molding member is provided. The inner surface of the molding die 31 of the pressing device 30 has a shape corresponding to at least the shape of the outer surface of the drill 400. That is, the molding die 31 has the inner shape corresponding to at least the shapes of the cutting edge 430a and the chip evacuation groove 410.

In the pressing process, at first, the diamond material 300 in which the binder is provided is filled into the field of the molding die 31 (having a first side where a first retaining member 33 is arranged) corresponding to the cutting edge 430a, while the binder-containing superhard alloy material 200 is filled into the field of the molding die 31 corresponding to the part of the drill 400 other than the cutting edge 430a arranged at the cutting portion 430b.

Thus, a second retaining member 32 is arranged at a second side of the molding die 31 in which the binder-containing diamond material 300 and the binder-containing superhard alloy material 200 are filled, to be pressed.

Thus, the molding member where the binder-containing diamond material 300 is provided at the field corresponding to the cutting edge 430a can be manufactured.

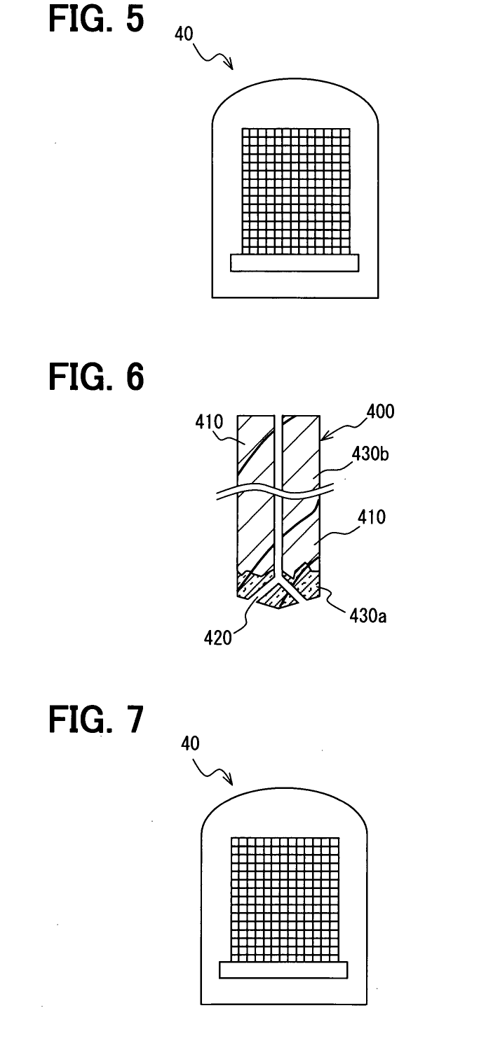

Next, as shown in FIG. 5, a preliminary sintering process (first sintering process) is performed in a sintering furnace 40. In this case, the binder of the molding member having been produced in the pressing process is degreased and preliminarily sintered. In this preliminary sintering process, the molding member is simply sintered so that the grains are joined to each other to have a solid shape.

Next, as shown FIG. 6, a perforation process is performed after the preliminary sintering process. In this process, the coolant supply hole 420 which has the opening at the cutting edge 430a is formed at the molding member having been preliminarily sintered.

The molding member having been preliminarily sintered has such a hardness that the solid shape of the molding member can be remained, after the preliminary sintering process. Thus, in the perforation process, a hole is formed at the molding member by a rod member or the like, so that the coolant supply hole 420 which has the opening at the cutting edge 430a to supply the coolant is formed.

Then, as shown in FIG. 7, a full-scale sintering process (second sintering process) is performed in the sintering furnace 40 to sinter the molding member, which has been preliminarily sintered and provided with the coolant supply hole 420, after the perforation process. In the preliminary sintering process and the full-scale sintering process, the sintering is performed at a temperature which is lower than a carbonization temperature of the diamond.

Thus, the drill 400 can be manufactured to have the chip evacuation groove 410 and provided with the opening of the coolant supply hole 420 which is formed at the cutting edge 430a (diamond portion) which is made of the diamond having a low compatibility with aluminum. Thus, the welding (deposition) of the chip can be substantially restricted.

### Other Embodiment

Although the present invention has been fully described in connection with the preferred embodiments thereof with reference to the accompanying drawings, it is to be noted that various changes and modifications will become apparent to those skilled in the art.

In the above-described exampled embodiment, the cutting tool according to the present invention is suitably used as the drill 400. However, the present invention can be also used as any cutting tool for processing (working) the nonferrous metal member (for example, aluminum member) or the like which has a low compatibility with the diamond. For example, the cutting tool can be used as a tap which is a tool for forming a screw.

Such changes and modifications are to be understood as being in the scope of the present invention as defined by the appended claims.

What is claimed is:

1. A cutting tool for processing a nonferrous metal member by rotation, the cutting tool comprising:
a body portion having a coolant supply hole through which a coolant is supplied for the nonferrous metal member in processing, and a chip evacuation groove which has a substantially helical shape and through which chip of the nonferrous metal member generated in the processing is expelled; and
a cutting edge which is arranged at the body portion and made of diamond grains and a binder material and at which an opening of the coolant supply hole is arranged.

2. The cutting tool according to claim 1, wherein
the chip evacuation groove and the coolant supply hole which are arranged at the body portion are spaced from each other.

3. The cutting tool according to claim 1, wherein
the chip evacuation grooves extends to the cutting edge.

4. A manufacture method for a cutting tool, comprising:
a pressing process for pressing a binder material and diamond grains which are filled in a field of a molding die corresponding to a cutting edge of the cutting tool and pressing a binder material and metal grains which are filled in a field of the molding die corresponding to a part of the cutting tool other than the cutting edge, so that a molding member is formed,
an inner surface of the molding die having a shape corresponding to at least the cutting edge and a chip evacuation groove of the cutting tool, the chip evacuation groove having a substantially helical shape;
a first sintering process for preliminarily sintering the molding member after the processing process;
a perforation process for forming a coolant supply hole which is arranged at the molding member having been preliminarily sintered and has an opening at the cutting edge, after the preliminary sintering process; and
a second sintering process for further sintering the molding member which has been preliminarily sintered and provided with the coolant supply hole, after the perforation process.

5. The manufacture method according to claim 4, wherein
in the first sintering process, the binder material of the molding member produced in the pressing process is degreased and the molding member is simply sintered so that the metal grains are joined to each other to have a solid shape.

6. The manufacture method according to claim 4, wherein
the first sintering process and the second sintering process are performed at a temperature which is lower than a carbonization temperature of the diamond.
